(19) United States
(12) Patent Application Publication
(10) Pub. No.: US 2004/0199518 A1
(43) Pub. Date: Oct. 7, 2004

(54) System and method for transition of information handling system configuration

(76) Inventor: Howard A. Shoobe, Austin, TX (US)

Correspondence Address: HAMILTON & TERRILE, LLP, P.O. BOX 203518, AUSTIN, TX, 78720, US

(21) Appl. No.: 10/407,703

(22) Filed: Apr. 4, 2003

(51) Int. Cl. G06F 7/00

(52) U.S. Cl. 707/100

(57) ABSTRACT

An automatic configuration transition engine determines a transition information handling system configuration for an existing information handling system configuration by selecting successor processing components to replace existing processing components based on transition factors, such as the relationship of existing and successor components, the cost of successor components, the availability of successor components and the processing components in a customer's existing and transition configurations so that the total number of processing components is reduced. A user interface supports network communication for determining an automatically generated transition configuration, for manually altering the automatically generated transition configuration with manually selected processing components and for generating a manufacturing image to manufacture information handling systems having the transition configuration.

### BACKGROUND OF THE INVENTION

1. Field of the Invention

The present invention relates in general to the field of manufacture of information handling systems, and more particularly relates to a system and method for transition from existing to succeeding configurations of manufactured information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally include a variety of information processing hardware components that work together to perform applications or otherwise process information. For instance, a typical information handling system will have a central processing unit that runs applications and stores information on temporary random access memory or permanent disk drive memory. The information is typically displayed through a graphics card and monitor or provided to a network through a network interface card. Although information handling systems are generally configured to have a set of information processing components that are classifiable by the type of function performed, the particular type of processing components included in a given information handling system configuration by a manufacture may vary widely. For example, central processing units generally improve in speed over time and storage devices generally increase in storage size and access speed over time. The continual improvement in the capability of processing components to process information has allowed information handling system manufacturers to produce information handling systems having ever greater operating capacity for processing information.

One difficulty that results from the constant change in available information processing components is that customers that purchase larger numbers of information handling systems tend to order the same or similar configurations to reduce the complexity of deployment and management of information handling systems across a business. For instance, a customer with similarly configured information handling systems are able to maintain a single hard disk drive image for that configuration with the same driver and utility software and firmware for the processing components of the existing configuration. The use of a reduced number of configurations for a given customer also simplifies the ordering and manufacturing or information handling systems by reducing the number of manufacturing images used and thus provides a more consistent product at reduced cost to the customer. However, a given customer's desire to maintain a reduced number of configurations is generally in conflict with a desire to field information handling systems having improved processing components for improved information processing. As the processing components of a given configuration grow outdated, customers are generally driven to change configurations for succeeding information handling systems that include updated processing components. With the large number of available processing components and the constant improvement in capability of processing components, the task of determining a configuration to transition to from an existing configuration presents a complex task.

### SUMMARY OF THE INVENTION

Therefore a need has arisen for a system and method which automatically determines a transition configuration for an existing information handling system configuration.

A further need exists for a system and method which aids in the definition of a transition configuration to reduce the complexity and improve the consistency of the transition configuration with the images of an existing information handling system inventory.

In accordance with the present invention, a system and method are provided which substantially reduce the disadvantages and problems associated with previous systems and methods for transitioning information handling system configurations from existing to succeeding processing components. A transition configuration is automatically determined for transitioning from an existing information handling system configuration by applying transition factors to the existing configuration processing components to select succeeding processing components.

More specifically, a customer interfaces through a network with an information handling system configuration transition tool to select an existing configuration for preparation of a transition configuration. An automatic configuration transition engine references a processing component relationship table for the existing configuration's processing components to identify succeeding processing components. The transition configuration is defined with the succeeding processing components which are selected based on transition factors that determine a logical successor for existing processing components based on compatibility, commonality, availability, relative performance, cost, manufacturer, driver similarity or other relevant factors, such as factors that improve management of the transition of the customer's image for the existing configuration to an image for the transition configuration. A common processing component engine analyzes available successor processing components and the customer's other existing configurations to bias the transition configuration to include processing components that minimize the number of different types of components used by the customer. A transition schedule engine analyzes successor processing component cost and availability to recommend a schedule for transition from manufacturing information handling systems with the existing configuration to manufacturing information handling system with the transition configuration. A manual configuration transition engine permits the customer to manually alter the automatically selected processing components. Once a transition configuration is determined, a customer may order an image for manufacture of systems having the transition configuration and may order a test system having the transition configuration.

The present invention provides a number of important technical advantages. One example of an important technical advantage is that a transition configuration for an existing information handling system configuration is automatically determined by identifying appropriate succeeding processing components to replace existing processing components in subsequently manufactured information handling systems. The automatically generated transition configuration reduces the cost and complexity of shifting to the use of improved processing components by balancing differences in the image of the transition configuration compared with the image of the configuration, such as results from driver, utility or other software or firmware changes, and with the cost and availability of processing components. Customers who determine a transition configuration more easily obtain valid and cost effective configurations to manage their inventory of information handling system purchases, obtain a suggested time schedule for the transition and may order test images and test information handling systems to confirm consistency of the transition configuration with an existing inventory.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system for determining an information handling system transition configuration; and

FIG. 2 depicts a process for determining an information handling system transition configuration.

### DETAILED DESCRIPTION

A configuration transition tool assists purchasers of information handling systems with the automated selection of successor processing components for manufacture of information handling systems to provide a desired transition from existing information handling system configurations. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

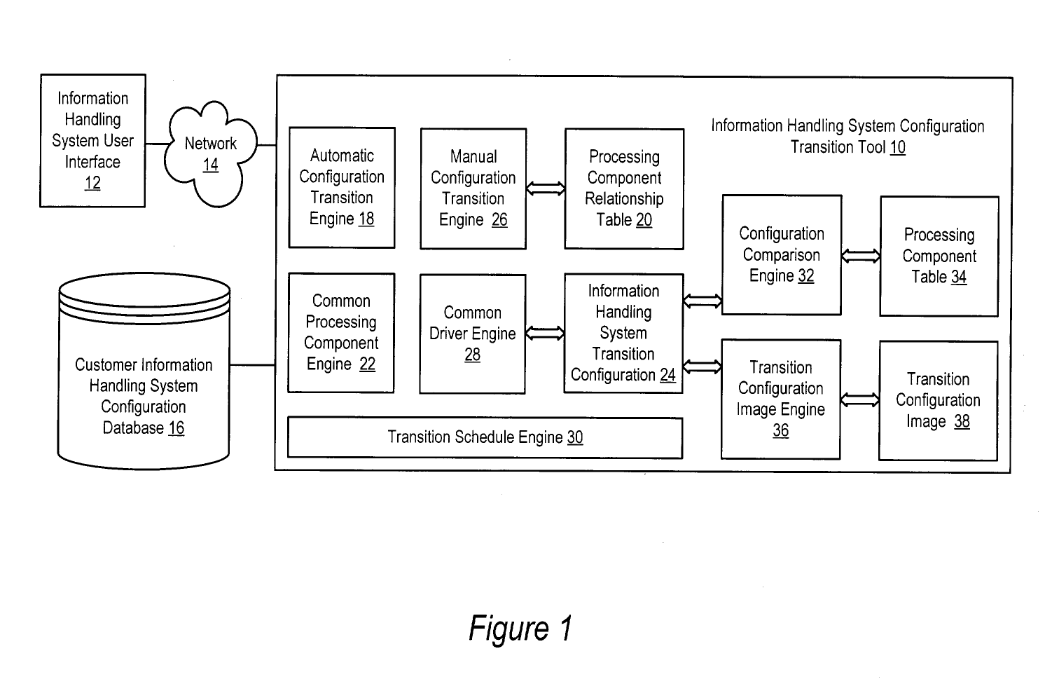

Referring now to FIG. 1, a block diagram depicts an information handling system configuration transition tool 10 that assists in the selection of successor processing components for defining a transition configuration to replace an existing information handling system configuration. Information handling system configuration transition tool 10 is, for instance, deployed on a server information handling system accessible by customer user interfaces 12 through a network 14, such as a browser interface through the Internet. Customers access their existing information handling system configurations from customer information handling system configuration database 16 to select an existing configuration for development of a transition configuration. Transition configurations that are saved to customer information handling system configuration database 16 are made available for the customer to order information handling systems with the transition configuration.

Once a customer selects an existing configuration from customer information handling system configuration database 16, an automatic configuration transition engine 18 determines a transition configuration for the selected configuration by applying transition factors. A processing component relationship table 20 provides automatic configuration transition engine 18 with suggested successor processing components to replace existing processing components. Processing component relationship table 20 is updated to reflect successor processing components as those components become available as well as the existing components that are recommended for replacement by the successor processing component. In addition, processing component relationship table 20 includes regional availability information for successor components which automatic configuration transition engine 18 applies by reference to the location at which the customer's information handling systems are manufactured. Automatic configuration transition engine 18 prioritizes successor processing components for each existing processing component that has a successor and then confirms the priority with a common processing component engine 22. Common processing component engine 22 searches customer information handling system configuration database 16 for existing configurations and transition configurations of the customer to bias selection of successor processor components based on the commonality of the processing components of the customer's inventory of information handling systems. For instance, processing components that are common among the greatest number of a customer's inventory are biased to have greater priority in selection for the transition configuration 24 to allow the customer to minimize its parts inventory.

Automatic configuration transition engine 18 presents the automatically generated information handling system transition configuration to the customer through user interface 12 as the recommend configuration to use in transition from the selected existing configuration and presents a number of options for the customer for further application of the transition configuration. One customer option is to override the suggested successor processing components with alternative components by manually interacting with processing component relationship table 20 through a manual configuration transition engine 26. For instance, the customer is presented with a matrix of configurations and available processing components that the customer may select to replace a suggested processing component. Another option available to the customer is to interact with common driver engine 28 to generate a comparison list between drivers for the selected, existing and transition configurations so that commonality of drivers and updates of existing drivers loaded on the customer's inventory of information handling systems may be accomplished. Based on cost information and availability for selected processing components, a transition schedule engine 30 suggests a schedule for proceeding with the transition from manufacture of information handling systems having the existing configuration to manufacture of information handling systems having the transition configuration. A configuration comparison engine 30 compares the existing and transition configurations to generate a processing component table 34 for convenient review by the customer. The customer may generate an transition configuration image 38 for manufacture of an information handling system having the transition configuration with a transition configuration image engine 36 to allow the customer to order a test system. The transition configuration 24 and image 38 are saved in customer information handling system configuration database 16 to await purchase orders.

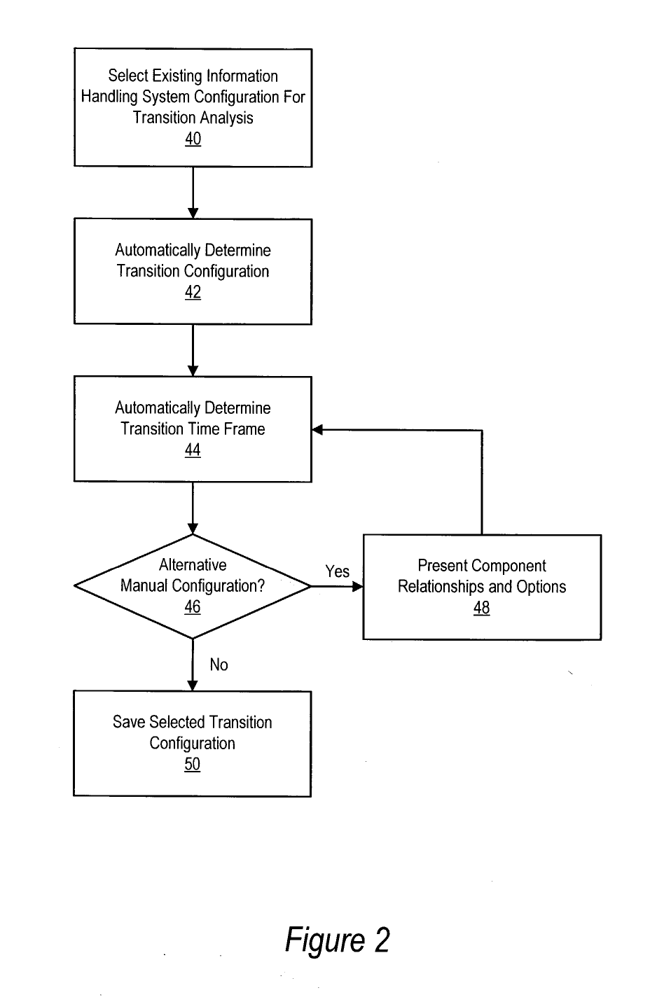

Referring now to FIG. 2, a flow diagram depicts a process for guiding information handling system configuration transition from an existing set of processing components to a set of successor processing components. The process begins at step 40 with the selection of an existing information handling system configuration for transition analysis. At step 42, an automatic determination of a transition configuration is made for the selected existing configuration based on transition factors, such as a relational database of existing and successor processing components. At step 44, a transition time frame is automatically generated for transition to the manufacture of information handling systems with the transition versus the existing configuration based on the cost and availability of the successor processing components. At step 46, a determination is made of whether to manually alter the suggested transition configuration with manual selection of processing components. If manual alteration is performed, the process continues to step 48 for a presentation of component relationships and options for selection by the customer. The process then returns to step 44 for a determination of a transition time frame for the manually altered transition configuration. If no manual alterations are performed at step 46, the process continues to step 50 for saving of the transition configuration to allow the customer to proceed with ordering of transition configuration information handling systems.

Although the present invention has been described in detail, it should be understood that various changes, substitutions and alterations can be made hereto without departing from the spirit and scope of the invention as defined by the appended claims.

What is claimed is:

1. A system for managing information handling system configuration transitions, the system comprising:
a processing component relationship table associating information handling system processing components according to one or more transition factors;
a customer information handling system configuration database storing customer information handling system configurations; and
an automatic configuration transition engine interfaced with the processing component relationship table and customer information handling system configuration database, the automatic configuration transition engine operable to automatically apply the transition factors to a selected customer information handling system configuration to determine a transition configuration associated with the selected customer information handling system.

2. The system of claim 1 wherein each information handling system configuration is a list of the processing components and associated drivers used to build an information handling system.

3. The system of claim 1 wherein the transition configuration comprises processing components automatically selected from the processing component relationship table, the system further comprising a manual configuration transition engine operable to manually replace one or more automatically selected processing components with manually selected processing components.

4. The system of claim 1 further comprising a configuration comparison engine operable to compare the selected information handling system configuration and the transition information handling system configuration to highlight differences between the configurations.

5. The system of claim 1 further comprising a transition configuration image engine operable to generate a hard disk drive image for manufacture of information handling systems having the transition configuration.

6. The system of claim 1 further comprising a transition schedule engine operable to schedule manufacture of information handling systems having the transition configuration based on cost and availability of processing components.

7. The system of claim 1 further comprising a common processing component engine interfaced with the automatic configuration transition engine and operable to monitor processing component selection for plural transition configurations to reduce the total number of processing components selected for the plural transition configurations.

8. The system of claim 7 further comprising a common driver engine interfaced with the common processing component engine and operable to monitor drivers associated with selected processing components to reduce the total number of drivers selected for the plural transition configurations.

9. The system of claim 1 further comprising a user interface operable to communicate with the automatic configuration transition engine through a network, the user interface further operable to save a transition information handling system to the customer information handling system configuration database.

10. A method for managing information handling system configuration transition from an existing configuration to a transition configuration, the method comprising:
selecting an existing information handling system configuration to transition;
automatically comparing each existing processing component of the existing information handling system configuration with associated available processing components to identify a successor processing component for each existing processing component; and
generating a transition configuration having the successor processing components.

11. The method of claim 10 further comprising:
associating each successor processing component with an availability and cost schedule; and
generating a transition schedule for manufacture of information handling systems having the transition configuration.

12. The method of claim 10 further comprising:
associating a driver with each successor processing component; and
generating an image for manufacture of information handling systems having the transition configuration.

13. The method of claim 10 wherein automatically comparing further comprises:
comparing the transition configuration with one or more other transition or existing configurations; and
identifying successor processing components to reduce the total number of successor components resulting from identifying the transition configurations.

14. The method of claim 13 wherein comparing the transition configuration further comprises comparing the transition configuration drivers with the drivers associated with the other transition or existing configurations.

15. The method of claim 10 further comprising manually altering the transition configuration to have alternative processing components.

16. An information handling system comprising:
a customer information handling system configuration database having existing information handling system configurations, each existing configuration including plural processing components;
a processing component relationship table associating processing components with successor processing components; and
an automatic configuration transition engine interfaced with the customer information handling system configuration database and the processing component relationship table, the automatic configuration transition engine operable to automatically generate a transition configuration for a selected existing configuration, the transition configuration having successor processing components.

17. The information handling system of claim 16 wherein the processing component relationship table further associates successor processing components with availability and cost information, the information handling system further comprising a transition schedule engine operable to apply the availability and cost information to generate a transition schedule for manufacture of information handling systems having the transition configuration.

18. The information handling system of claim 16 further comprising a transition configuration image engine operable to generate an image for manufacture of information handling systems having the transition configuration.

19. The information handling system of claim 16 further comprising a manual configuration transition engine interfaced with the automatic configuration transition engine and operable to alter the automatically generated transition configuration with manually selected processing components.

20. The system of claim 16 further comprising a common processing component engine interfaced with the automatic configuration transition engine and the customer information handling system configuration database, the common processing component engine operable to bias successor processing component selection of the automatic configuration transition engine based on the components associated with plural configurations of a customer.
